(19) United States
(12) Patent Application Publication
(10) Pub. No.: US 2022/0322697 A1
(43) Pub. Date: Oct. 13, 2022

(54) Confectionery Item

(71) Applicant: Mark Rocha, San Marcos, TX (US)

(72) Inventor: Mark Rocha, San Marcos, TX (US)

(21) Appl. No.: 17/809,161

(22) Filed: Jun. 27, 2022

Related U.S. Application Data
(63) Continuation-in-part of application No. 16/560,757, filed on Sep. 4, 2019, now abandoned.
(60) Provisional application No. 62/727,108, filed on Sep. 5, 2018.

(51) Int. Cl. A23G 9/48; A23G 9/32

(52) U.S. Cl. CPC A23G 9/48; A23G 9/322; A23V 2002/00

(57) ABSTRACT

Products and associated methods relate to a confectionery item having a boundary layer configured to prevent spun sugar of the confectionery item from breaking down. In an illustrative example, a confectionery item may include a frozen food core, a boundary layer configured to wrap the frozen food core, and a spun sugar layer configured to surround the boundary layer. In some embodiments, the boundary layer may be pliable at room temperature and hard at freezing temperatures. By adding the boundary layer, the frozen food core may, in some embodiments, not dissolve (e.g., “burn” or “eat” through) the spun sugar.

### CROSS-REFERENCE TO RELATED APPLICATIONS

This application is a Continuation-in-Part and claims the benefit of U.S. application Ser. No. 16/560,757, titled “Confectionery Item,” filed by Mark Rocha, on Sep. 4, 2019, which application claims the benefit of U.S. Provisional Application Ser. No. 62/727,108, titled “Confectionery Item,” filed by Mark Rocha, on Sep. 5, 2018.

This application incorporates the entire contents of the foregoing application(s) herein by reference.

### TECHNICAL FIELD

Various embodiments relate generally to confectionery items.

### BACKGROUND

Ice cream is a sweetened frozen food typically eaten as a snack or dessert. It may be made from dairy milk or cream and is flavored with a sweetener, either sugar or an alternative, and any spice, such as cocoa or vanilla. Colorings are usually added, in addition to stabilizers. The mixture is stirred to incorporate air spaces and cooled below the freezing point of water to prevent detectable ice crystals from forming. The result is a smooth, semi-solid foam that is solid at very low temperatures. Ice cream becomes more malleable as its temperature increases. Vegan ice cream-substitutes can be made using soy, cashew, coconut, or almond milk.

### SUMMARY

Products and associated methods relate to a confectionery item having a boundary layer configured to prevent spun sugar of the confectionery item from breaking down. In an illustrative example, a confectionery item may include a frozen food core, a boundary layer configured to wrap the frozen food core, and a spun sugar layer configured to surround the boundary layer. In some embodiments, the boundary layer may be pliable at room temperature and hard at freezing temperatures. By adding the boundary layer, the frozen food core may, in some embodiments, not dissolve (e.g., “burn” or “eat” through) the spun sugar.

Various embodiments may achieve one or more advantages. For example, some embodiments may use different flavors of frozen food core and boundary layer to provide customers with rich tasting experiences. Some embodiments may provide a handheld confectionery item that enables customers to enjoy the confectionery item while walking. Some embodiments may provide Miller crepe styled confectionery items with rich taste with multiple frozen food layers and multiple boundary layers.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a cross-sectional view of an exemplary confectionery item.

FIG. 2A and FIG. 2B depict perspective views illustrating an exemplary process for making the confectionery item.

FIG. 3 depicts promotional materials illustrating exemplary confectionery items.

FIG. 4 depicts a flowchart illustrating an exemplary method of making the confectionery item.

FIG. 5 depicts a cross-sectional view of another exemplary confectionery item.

FIG. 6 depicts an exemplary confectionery item with illustrative dimensions.

FIG. 7 depicts an exemplary confectionery item with illustrative weights with and without an uncompressed outer covering.

FIG. 8 depicts an exemplary enclosure having a rollup fruit-flavored sheet enclosing a frozen food core.

FIG. 9 depicts an exemplary process for covering an exemplary confectionery item with an outer covering of spun sugar.

FIG. 10 depicts a flowchart illustrating an exemplary method of making the confectionery item.

Like reference symbols in the various drawings indicate like elements.

### DETAILED DESCRIPTION OF ILLUSTRATIVE EMBODIMENTS

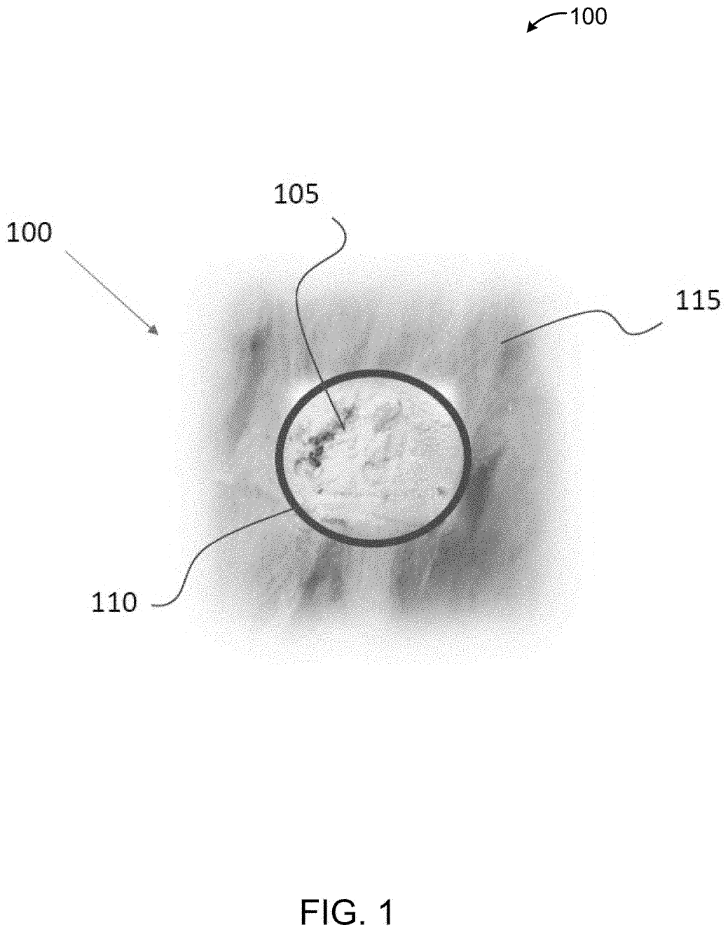

FIG. 1 depicts a cross-sectional view of an exemplary confectionery item. A confectionery item 100 includes a frozen food core 105. In some embodiments, the frozen food core 105 that makes up the core 105 may be ice cream or frozen yogurt, for example. Enclosing the core 105 is a boundary layer 110. In some examples, the boundary layer 110 may be a thin, pectin-based fruit-flavored snack, such as a Fruit Roll-Up® produced by General Mills®. In various examples, the layer 110 may be a thin, sugar-based substance that is pliable at room temperature and hard at freezing temperatures. In various embodiments, the layer 110 may include multiple thin, sugar-based layers. Surrounding the layer 110 is an outer covering of spun sugar 115. In various examples, the spun sugar 115 may be cotton candy, which may be machine spun.

The layer 110 may solve a problem identified by the inventor that in the absence of the layer 110 (e.g., where core 105 and spun sugar 115 are in physical contact), the core 105 would dissolve (“burn” or “eat” through) the spun sugar 115. By adding the layer 110, a boundary is formed between the core 105 and the spun sugar 115, thus preventing the spun sugar 115 from breaking down. Accordingly, the addition of the layer 110 may solve the problem of how to prevent the ice cream 105 from breaking down the cotton candy 115. In various examples, the layer 110 may be referred to as an “intermediate layer,” while the spun sugar layer 115 may be referred to as an “outer layer.”

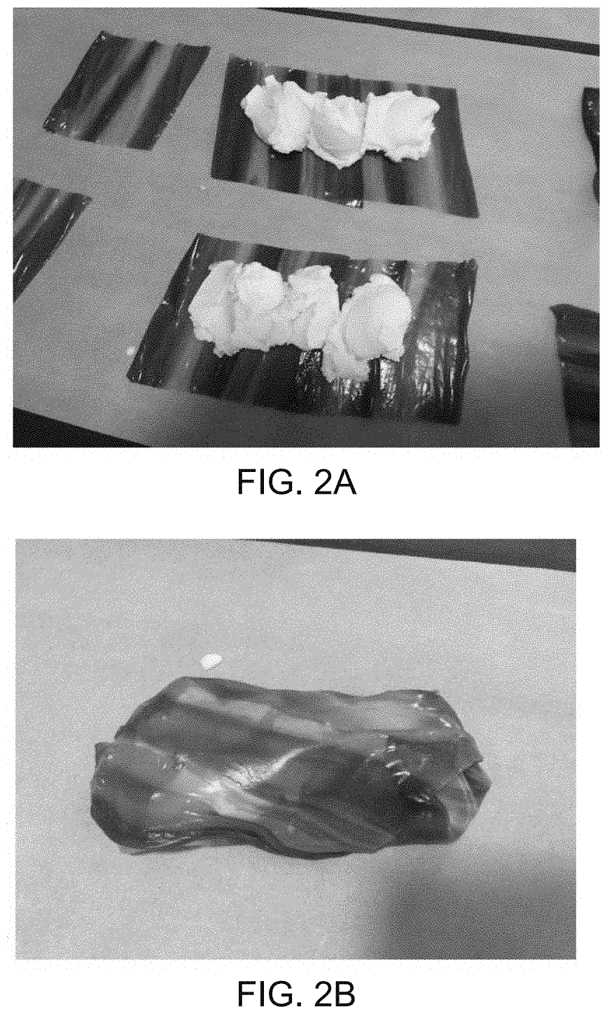

FIGS. 2A and 2B depict perspective views illustrating an exemplary process for making the confectionery item. At least one rollup fruit-flavored sheet is laid down on a surface such as a table (FIG. 2A). Next, at least one portion of ice cream is placed centrally on top of the at least one rollup fruit-flavored sheet (FIG. 2B). Next, the at least one rollup fruit-flavored sheet is molded around the at least one portion of ice cream to completely surround the ice cream in fruit roll up (FIG. 2B). At this stage, additional rollup fruit-flavored sheets may be used to completely surround the ice cream and provide for a thicker boundary layer. Next, the ice cream encased in fruit roll up is then covered with an outer covering of cotton candy (not shown).

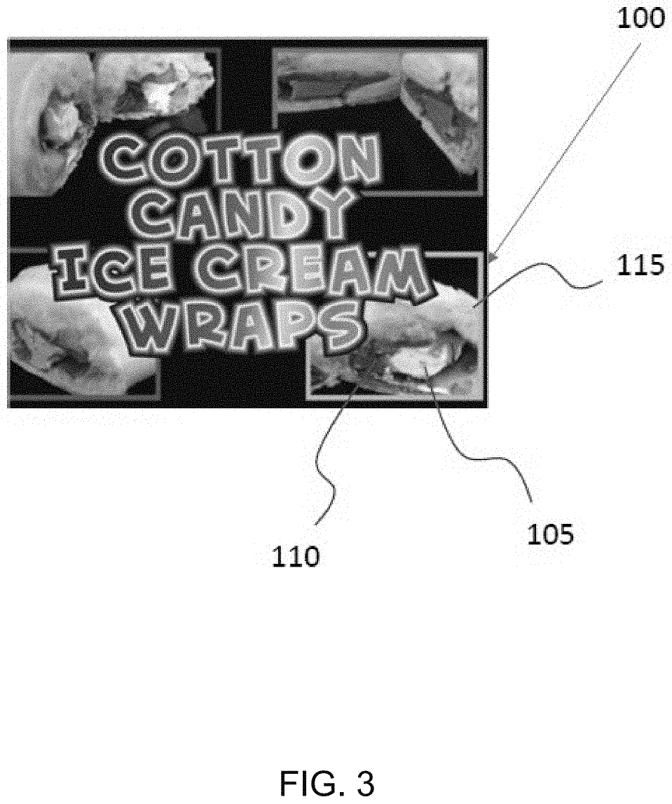

FIG. 3 depicts promotional material illustrating exemplary confectionery items. A confectionery item 100 is shown with a core 105 made of ice cream, an intermediate layer 110 made of rollup fruit-flavored sheet, and an outer covering of cotton candy 115. The intermediate layer 110 may advantageously act as a buffering layer to prevent the ice cream core 105 from breaking down the cotton candy cover 115.

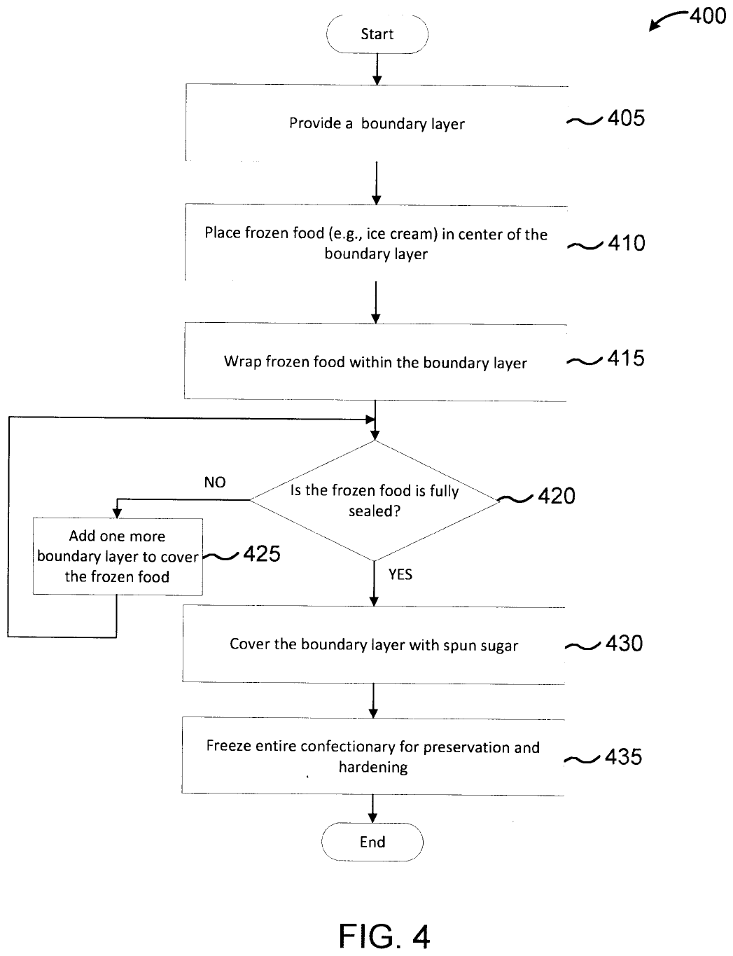

FIG. 4 depicts a flowchart illustrating an exemplary method of making the confectionery item. A manufacturing process 400 starts with providing a boundary layer (e.g., laying down a boundary layer on a surface) at 405, where the boundary layer may be a thin, sugar-based substance like a rollup fruit-flavored sheet, for example. Next, at, 410, frozen food (e.g., ice cream) is placed near the center of the (laid-down) boundary layer. At 415, the frozen food is wrapped in the boundary layer.

Then, whether the frozen food core is fully sealed by the boundary layer is decided 420. If the frozen food core is not fully sealed, additional boundary layers may be added 425 to fully enclose and seal the frozen food and provide a sufficiently thick buffer until the frozen food is fully sealed. If yes, then, the method 400 includes, at 430, the frozen food enclosed in boundary layer(s) is covered with spun sugar, which may be cotton candy, for example. At this stage, it may be said that the entire confectionery resembles an “ice cream burrito.” Next, at 435, the entire confectionery (ice cream core, rollup fruit-flavored sheet intermediate layer, and cotton candy outer covering) is frozen for preservation and to harden the confectionery. Freezing the confectionery may allow the confectionery to be easily sliced and cut into pieces for individual serving to a customer. When the confectionery is cut, it may exhibit a “smoking” effect (like freeze dried ice cream).

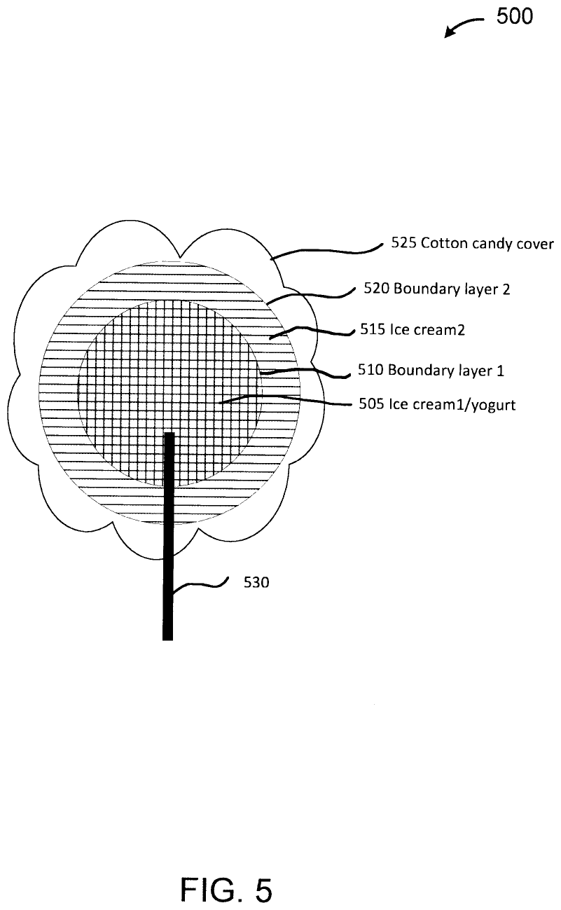

FIG. 5 depicts a cross-sectional view of another exemplary confectionery item. A confectionery item 500 includes a first frozen food core 505. In some embodiments, the frozen food that makes up the core 505 may be ice cream or frozen yogurt, for example. Enclosing the core 505 is a first boundary layer 510. In some examples, the boundary layer 510 may be a thin, pectin-based fruit-flavored snack, such as a Fruit Roll-Up® produced by General Mills®. In various examples, the first boundary layer 510 may be a thin, sugar-based substance that is pliable at room temperature and hard at freezing temperatures. In various embodiments, the first boundary layer 510 may include multiple thin, sugar-based layers.

The confectionery item 500 also includes a second frozen food core 515. In some embodiments, the frozen food that makes up the core 515 may be ice cream or frozen yogurt, for example. Enclosing the core 515 is a second boundary layer 520. In some examples, the boundary layer 520 may be a thin, pectin-based fruit-flavored snack, such as a Fruit Roll-Up® produced by General Mills®. In various examples, the first boundary layer 520 may be a thin, sugar-based substance that is pliable at room temperature and hard at freezing temperatures. In various embodiments, the first boundary layer 520 may include multiple thin, sugar-based layers. In some embodiments, the first frozen food core 505 and the second frozen food core 515 may be the same product (e.g., both are vanilla flavored ice creams), In some embodiments, the first frozen food core 505 and the second frozen food core 515 may be different products (e.g., one is vanilla flavored ice cream and the other one is chocolate flavored ice cream). Thus, people may taste multiple flavors with one bite. In some embodiments, the second frozen food core 515 may be replaced by other confectionery food, rather than frozen food. Surrounding the second boundary layer 520 is an outer covering of spun sugar 525. In various examples, the spun sugar 525 may be cotton candy, which may be machine spun. In some embodiments, the confectionery item 500 may include more frozen food cores and covered by corresponding boundary layers to form a Mille crepe confectionery item. In some embodiments, the confectionery item 500 may also include a supporting item 530 (e.g., a wooden stick, a chocolate stick, Wafer stick), therefore, people can handhold the confectionery item 500. Other shapes (e.g., conical) of the confectionery item 500 may also be made.

The layers 510, 520 may solve a problem identified by the inventor that in the absence of the layers 510, 520 (e.g., where core 515 and spun sugar 525 are in physical contact), the core 515 would dissolve (“burn” or “eat” through) the spun sugar 525. By adding the layers 510, 520, boundaries are formed between the core (e.g., 505, 515) and the spun sugar 525, thus preventing the spun sugar 525 from breaking down. Accordingly, the addition of the layers 510, 520 may solve the problem of how to prevent the ice cream 505, 515 from breaking down the cotton candy 525. In various examples, the layers 510, 520 may be referred to as “intermediate layers,” while the spun sugar layer 525 may be referred to as an “outer layer.”

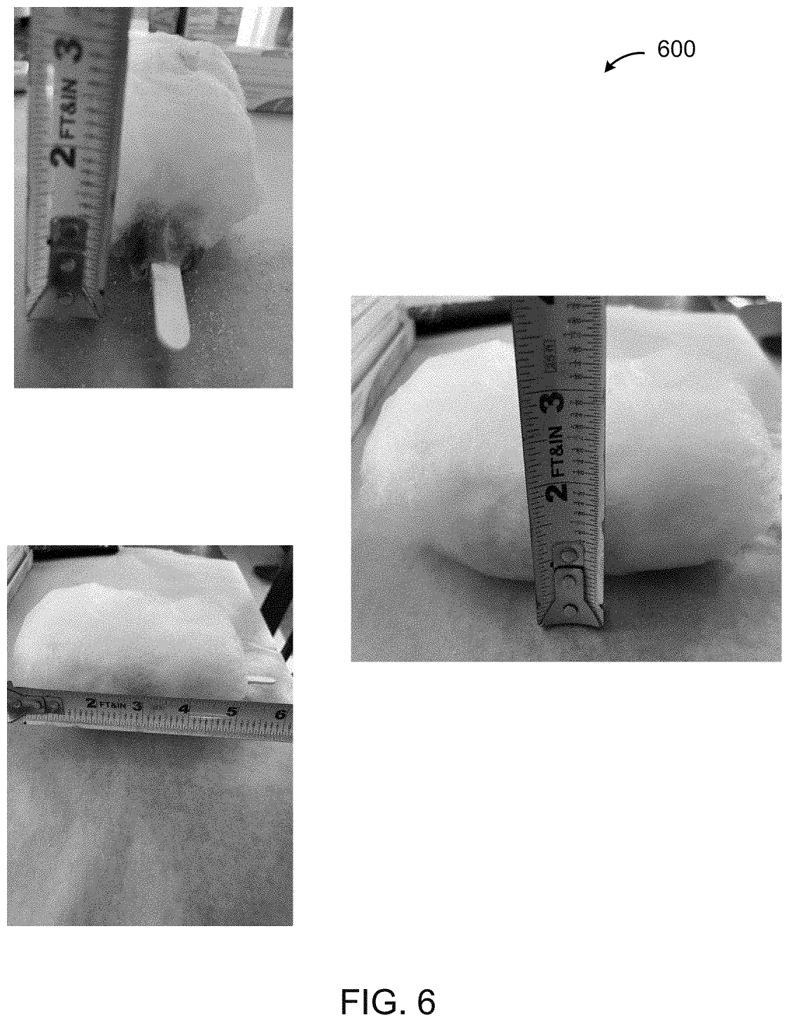

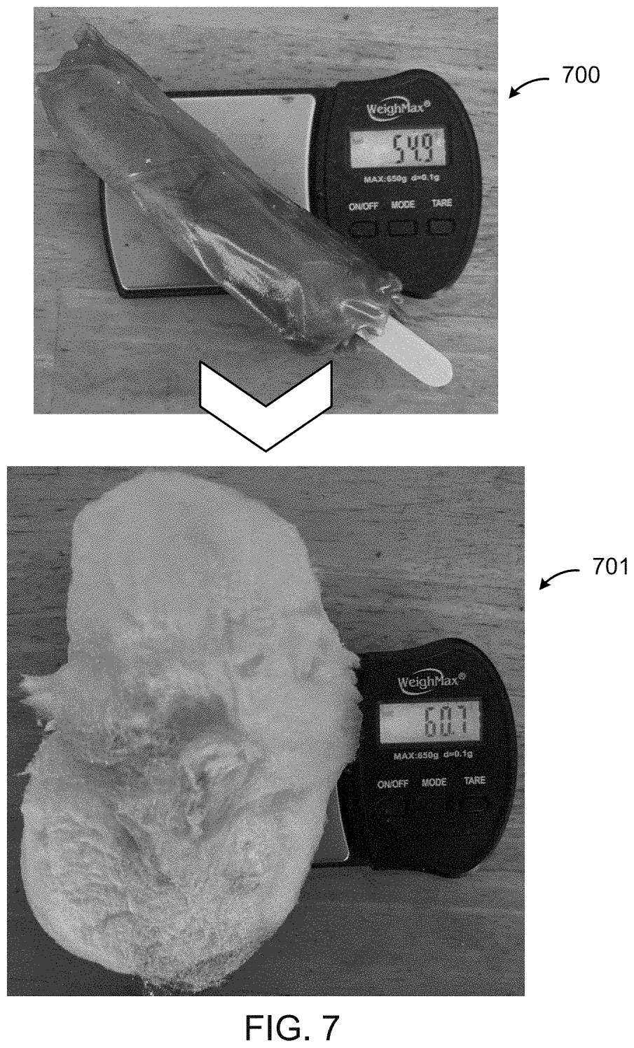

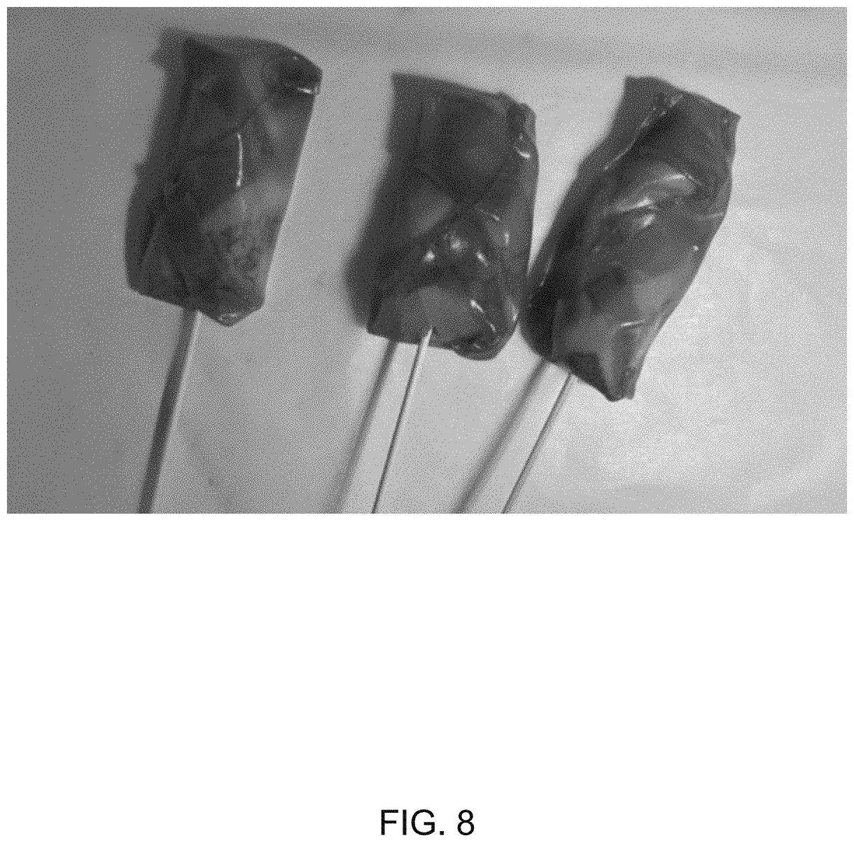

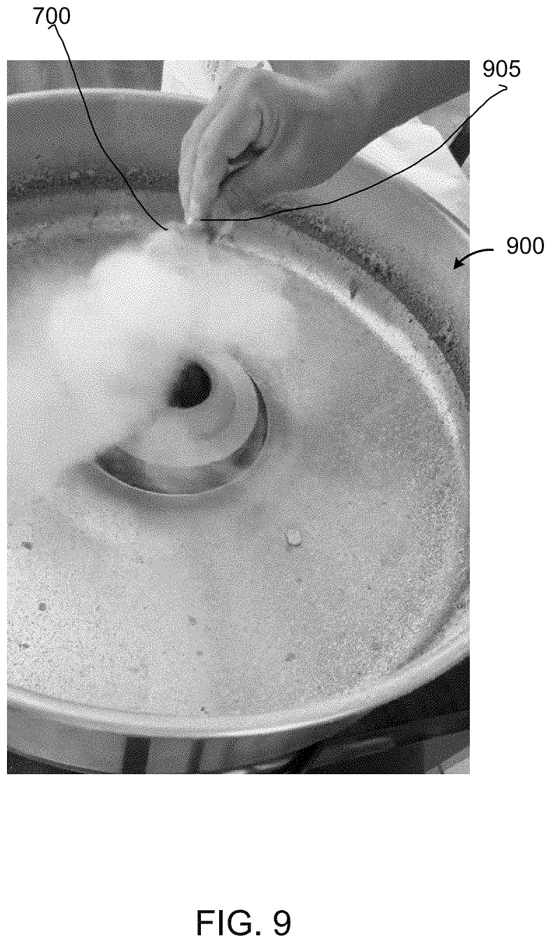

FIG. 6 depicts an exemplary confectionery item 600 with illustrative dimensions. FIG. 7 depicts an exemplary confectionery item with illustrative weights with and without an uncompressed outer covering. FIG. 8 depicts an exemplary enclosure having a thin shell (e.g., of rollup fruit-flavored sheet, as depicted) enclosing a frozen food core. FIG. 9 depicts an exemplary process for covering an exemplary confectionery item with an outer covering of spun sugar.

In some implementations, an exemplary confectionery item may include, corresponding to size in the illustrative examples shown in FIGS. 6-9, less than 200 calories per serving. In some examples, the confectionery item may include 2.5 oz or less of ice-cream. For example, the confectionery item may advantageously provide a unique experience in eating a big snack while intaking relatively little energy.

As shown in FIG. 7, a shell 700 (e.g., made of rollup fruit-flavored sheet) may be filled with frozen core food (e.g., soft-serve ice cream) to a first total mass (e.g., 54.9 g in the depicted example). After cotton candy is spun on the shell 700, a confectionery item 701 may have a second total mass less than a predetermined maximum spun sugar mass (e.g., 60.7 g in the depicted example, where 60.7 g−54.9 g=5.8 g, which is less than an illustrative maximum spun sugar mass of 11 g), adding very little sugar with an obvious visual effect of enlargement.

As shown in FIG. 8, the shell (e.g., of rollup fruit-flavored sheet) may be thin. In some implementations, by way of example and not limitation, the shell may be 3 mm thick or less. Some embodiments may, for example, have a shell no thicker than 2 mm. In some implementations, a thin shell may have a maximum thickness (T_{S}) of 1 mm.

A thin shell (e.g., T_{S}≤3 mm, T_{S}≤2 mm, T_{S}≤1 mm) may for example, advantageously reduce calories contributed by the shell material. In some examples, the shell may, for example, have a size of 5 inches×5 inches or less, when laid flat.

In some implementations, by way of example and not limitation, the thin shell may advantageously provide a thermal and/or moisture barrier between the frozen food core (e.g., a high-moisture, temperature sensitive substance such as ice cream) and an exterior layer (e.g., a moisture-sensitive substance such as spun sugar). For example, the thin shell may advantageously provide a thermal and/or moisture barrier while limiting a contribution to a combined taste of the confection. For example, a consumer may wish to eat spun sugar and ice cream together (e.g., at an outdoor event) while enjoying the true spun sugar experience (e.g., uncompressed) and without the ice cream melting the spun sugar. The consumer may, for example, enjoy an extra ‘touch’ of flavor from a shell (e.g., a rollup fruit-flavored sheet in a complementing flavor), but not wish the delicate taste of the spun sugar and/or ice cream to be overpowered. The consumer may, for example, not want the texture of the spun sugar and/or ice cream to be interfered with by a thick boundary layer. Accordingly, for example, a thin shell may advantageously provide the barrier layer and/or enjoyment (a ‘touch’ of extra flavor) without overpowering a desired combination of taste and/or texture.

In some examples, the confectionery item 701 may be made using a sugar spun machine 900 as shown in FIG. 9. As shown in FIG. 9, the spun sugar may be applied by a vertical discharge machine such that the spun sugar may be directly applied to substantially an entire exterior surface of the shell 700. As shown, the rollup fruit-flavored sheet 905 may be skewered before being spun with spun sugar in the sugar spun machine 900.

In some implementations, the confectionery item may be made with soft-serve ice-cream loaded into a pre-made shell. For example, the pre-made shell may be made from a rollup fruit-flavored sheet sheet. For example, a measured amount (e.g., 9 g, 11 g, 13-20 g) of spun sugar may be added to the rollup fruit-flavored sheet. For example, an outer layer of spun sugar may be more than ¼ inches thick. For example, the density (ρ) of the outer layer of spun sugar may be less than 0.7 g/cm³. For example, some embodiments may be configured such that the outer layer of spun sugar has ρ≤0.6 g/cm³. Some embodiments may be configured to have the outer layer of spun sugar such that ρ≤0.5 g/cm³. For example, ρ≤0.4 g/cm³. In some implementations, the outer layer may, for example (such as depicted at least in FIG. 7 and FIG. 9), be ‘extra-fluffy’ such that ρ≤0.3 g/cm³. For example, the density may be chosen based on a texture and/or thermal insulation target. For example, p may be inversely proportional to R-value (e.g., decrease p corresponding to increased R-value, at least within a range).

In some implementations, by way of example and not limitation, an uncompressed and/or low density spun sugar layer may advantageously increase appeal of the resulting confection. For example, the low density spun sugar layer may advantageously provide a greater visual size of the confection, helping a consumer feel more satisfied in eating the product while not actually consuming additional calories. In some examples, the low density spun sugar layer may advantageously preserve a texture and/or experience of eating spun sugar associated with uncompressed and/or low-density spun sugar. For example, at least in some implementations, a process may specifically avoid flattening or compressing the spun sugar layer (e.g., at least beyond ‘shaping’ of the spun sugar into a desired outer shape, at least greater than a density of 0.7 g/cm³). In some such implementations, the rollup fruit-flavored sheet 905 may advantageously prevent thermal and/or moisture transport between the spun sugar layer and the frozen food core, and thereby prevent melting without flattening and/or compressing the spun sugar.

An uncompressed and/or low density (e.g., ρ≤0.7 g/cm³) spun sugar layer may, for example, advantageously increase thermal insulative value (e.g., R-value, corresponding to resistance to thermal conduction) of the spun sugar. A lower density may correspond to a higher R-value per thickness. Accordingly, a same total amount of spun sugar (e.g., measured in calories), when uncompressed, may advantageously provide a higher thermal insulation without increasing calories. For example, the density of spun sugar may be selected to reach a desired R-value. In some implementations, the R-value of spun sugar may be approximated by an R-value of spun glass (e.g., fiberglass) insulation (e.g., R-2.2/inch to R-5/inch depending on density).

In some examples, the shell (e.g., rollup fruit-flavored sheet) may advantageously prevent hot air from directly contacting the frozen food core. The spun sugar may, by way of example and not limitation, act as insulation to attenuate radiation, convection, and/or conduction between an external environment and the rollup fruit-flavored sheet. For example, a thick spun sugar layer (e.g., ¼ inch or more) may prevent or limit condensation forming on the rollup fruit-flavored sheet. In various implementations, the confectionery item 100 may last more than 10 minutes with users walking around in their hand.

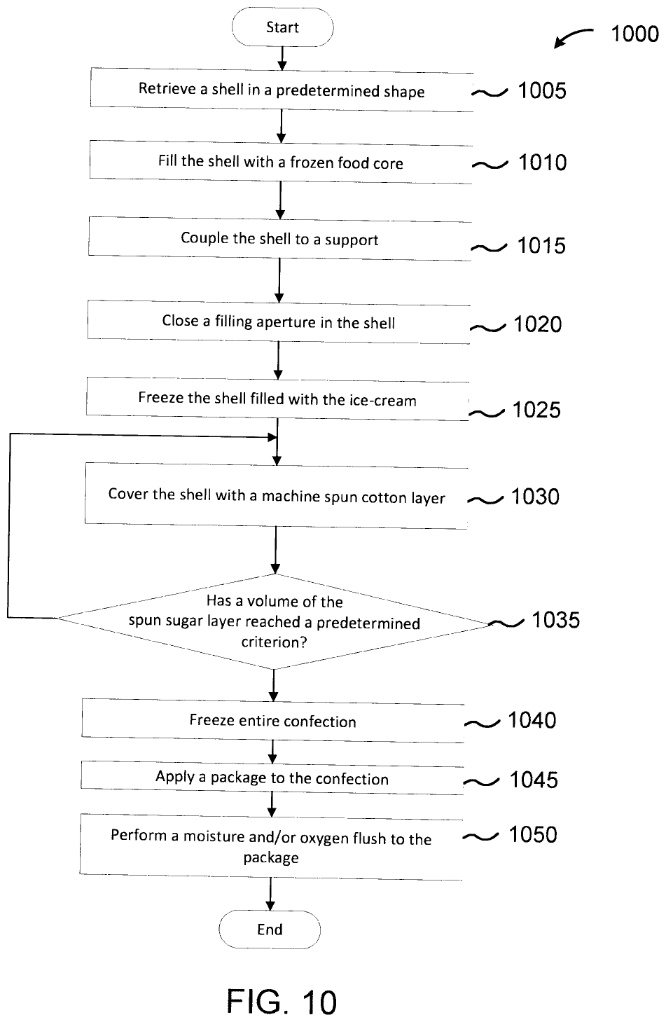

FIG. 10 depicts a flowchart illustrating an exemplary method 1000 of making the confectionery item. The method 1000 begins when a shell in a predetermined shape is retrieved in step 1005. In some implementations, for example, the method 1000 may include forming the shell into a predetermined shape (step not shown). The shell may be formed, for example, to have at least one aperture suitable for filling the shell with a frozen food core. For example, a rollup fruit-flavored sheet may be pre-made into a shell having a predetermined shape and defining a substantially continuous cavity formed to receive a predetermined volume of frozen food core. In step 1010, the shell is filled with a frozen food core (e.g., soft-serve ice-cream). Next, in step 1015, the shell is coupled to a support (e.g., skewered).

In some implementations, the shell may be coupled to the support after being filled. In some implementations, the shell may be refrigerated and/or frozen before being filled (e.g., to reduce melting of the frozen food core, to set a shape of the shell).

A filling aperture (e.g., pre-formed, formed during filling) in the shell is closed in step 1020. Closing the shell may, for example, form a substantially continuous moisture and/or thermal boundary around the frozen food core. The shell may, for example, be closed by pinching its edges together. The material of the shell may, for example, self-adhere (e.g., rollup fruit-flavored sheet). In some implementations, the step may include moistening at least one edge of the shell to induce adherence.

Next, the shell filled with the frozen food core is frozen in step 1025. In some implementations, the shell filled with the frozen food core may be frozen in a walk-in freezer. For example, the rollup fruit-flavored sheet filled with the ice-cream may be laid on a flat steel sheet pan with wax paper, and then stored in the walk-in freezer for 30-40 minutes. For example, after being frozen, the rollup fruit-flavored sheet filled with the ice-cream may be cooled to sub-zero temperatures. In various implementations, the low temperature may create a smoking effect when the shell is broken during use (e.g., eating, serving), and moisture in the frozen food core begins sublimating. In some implementations, trapped moisture in the frozen food core (e.g., contained by the shell) may condensate as water vapor to form a fog (e.g., distributed water droplets), forming the ‘smoking’ effect. For example, the low-density spun sugar layer together with the moisture-barrier shell may advantageously maintain a minimum temperature and/or moisture difference between the frozen food core and an ambient environment such that the smoking effect is achieved.

In step 1030, the shell is covered with a machine spun sugar layer (e.g., ‘cotton candy’). For example, the machine spun sugar layer may be shot onto an exterior surface (e.g., an entire exterior surface) of the shell using a machine described with reference to FIG. 9. In a decision point 1035, it is determined whether a volume of the spun sugar layer has reached a predetermined criterion. For example, the cotton candy layer may be required to reach a thickness of at least ¼ inches thick and/or a mass of at least N grams (e.g., 5 grams, 7 grams, 11 grams). If it is determined that the volume of the spun sugar layer has not reached the predetermined criterion, the step 1030 is repeated. In some implementations, the decision point 1035 may be omitted. For example, a predetermined amount (e.g., mass, volume, caloric equivalent) of spun sugar may be applied (e.g., by dispensing a measure amount of sugar as spun sugar onto the shell).

If it is determined that the volume of the spun sugar layer has reached the predetermined criterion, in step 1040, the entire confection is frozen (e.g., re-frozen). For example, after freezing, the cotton candy layer may advantageously be held in hand for a longer period of time without melting.

In a step 1045, a package is applied to the confection (e.g., a polymeric wrapper, a thermal barrier, a moisture barrier). In a step 1050, a moisture and/or oxygen flush is performed and the method 1000 ends. For example, the flush may include flushing the package with nitrogen gas to achieve a desired maximum thermal and/or oxygen level. The nitrogen flush may, for example, prevent degradation of the spun sugar, the shell, and/or the frozen food core.

Although various embodiments have been described with reference to the figures, other embodiments are possible. For example, other materials may be added on the cotton layer. In some embodiments, chocolate beans may be added in the frozen core.

In an exemplary aspect, a confectionery item includes a frozen food core that comprises ice cream, a boundary layer configured to wrap the frozen food core, and a spun sugar layer configured to surround the boundary layer, the boundary layer is pliable at room temperature and hard at freezing temperatures.

In some embodiments, the boundary layer may be a thin and sugar-based substance. In some embodiments, the boundary layer may be a fruit-flavored snack. In some embodiments, the boundary layer may be a fruit roll-up. In some embodiments, the spun sugar layer may be cotton candy. In some embodiments, the spun sugar layer may be machine-spun cotton candy.

In another exemplary aspect, a confectionery item includes a first frozen food core, a first boundary layer configured to wrap the first frozen food core, and a spun sugar layer configured to surround the first boundary layer, the boundary layer is pliable at room temperature and hard at freezing temperatures.

In some embodiments, the frozen food core may be ice cream. In some embodiments, the frozen food core may be frozen yogurt. In some embodiments, the boundary layer may be a thin and sugar-based substance. In some embodiments, the boundary layer may be a fruit-flavored snack. In some embodiments, the spun sugar layer may be machine-spun cotton candy. In some embodiments, the confectionery item may also include a second frozen food core and a second boundary layer configured to wrap the second frozen food core. The first frozen food core may be placed between the second boundary layer and the first boundary layer. In some embodiments, the second frozen food core may be a different product from the first frozen food core. In some embodiments, the confectionery item may be a handheld confectionery item.

In another exemplary aspect, a method of making a confectionery item includes providing a boundary layer, placing frozen food in the boundary layer, wrapping the frozen food within the boundary layer, and covering the boundary layer with spun sugar, the boundary layer is pliable at room temperature and hard at freezing temperatures.

In some embodiments, the boundary layer may be a thin and sugar-based substance. In some embodiments, the boundary layer may be a fruit-flavored snack. In some embodiments, the boundary layer may be a Fruit roll-up. In some embodiments, the spun sugar layer may be machine-spun cotton candy.

In an exemplary aspect, a melting-resistant spun sugar and frozen liquid confection may include an edible housing including a moisture-resistant molded shell. The confection may include a frozen liquid food core substantially entirely enclosed by the edible housing. The confection may include an uncompressed spun sugar blanket including a machine-spun cotton candy configured to substantially encompass the edible housing enclosing the frozen liquid food core. The uncompressed spun sugar blanket may have a density less than 0.7 g/cm³. The uncompressed spun sugar blanket may be preserved, by the edible housing, from being dissolved by the frozen liquid food core. The frozen liquid food core may be thermally insulated from an ambient environment by the uncompressed spun sugar blanket.

The edible housing may include a rollup fruit-flavored sheet pre-molded into a predetermined shape. The moisture-resistant molded shell may be less than 2 mm thick.

The frozen liquid food core may include a continuous ice-cream core. The frozen liquid food core may include less than 3 oz of continuous ice-cream. A total mass of the frozen liquid food core and the enclosing edible housing may be less than 60 g.

The confection may have a volume of more than 42 cm³.

The confection may be configured to have less than 200 kcal of calories.

The uncompressed spun sugar blanket may be at least ¼ inch thick. The blanket may encompass the edible housing enclosing the frozen liquid food core.

In an exemplary aspect, a melting-resistant spun sugar and frozen liquid confection may include an edible housing including a moisture-resistant molded shell. The confection may include a frozen liquid food core substantially entirely enclosed by the edible housing. The confection may include an uncompressed spun sugar blanket configured to substantially encompass the edible housing enclosing the frozen liquid food core. The uncompressed spun sugar blanket may be preserved, by the edible housing, from being dissolved by the frozen liquid food core. The frozen liquid food core may be thermally insulated from an ambient environment by the uncompressed spun sugar blanket.

The shell may include a rollup fruit-flavored sheet pre-molded into a predetermined shape. The rollup fruit-flavored sheet may be a maximum of 5 inches square when in an un-molded state. The moisture-resistant molded shell may be less than 2 mm thick.

The frozen liquid food core may include a continuous ice-cream core. The continuous ice-cream core may include soft-serve ice cream. The frozen liquid food core may include less than 3 oz of continuous ice-cream. A total mass of the frozen liquid food core enclosed by the edible housing may be less than 60 g.

The melting-resistant spun sugar and frozen liquid confection may have a volume of more than 42 cm³. The melting-resistant spun sugar and frozen liquid confection may include less than 200 kcal of calories.

The uncompressed spun sugar blanket may include a machine-spun cotton candy. The uncompressed spun sugar blanket may have a density less than 0.7 g/cm³. The uncompressed spun sugar blanket may be at least ¼ inch thick encompassing the edible housing enclosing the frozen liquid food core.

In an exemplary aspect, a method of making a spun sugar confection may include provide an edible housing including a shell molded to a predetermined shape such that the shell defines a cavity. The method may include couple a support to the edible housing. The method may include fill the cavity of the edible housing with a frozen food core through at least one aperture in the shell. The method may include enclose the frozen food core within the edible housing by sealing a first portion of the shell to a second portion of the shell such that the at least one aperture is sealingly closed. The method may include freeze the frozen food core enclosed by the edible housing. The method may include apply, while supporting the edible housing using a support coupled to the edible housing, spun sugar onto an exterior surface of the edible housing to create an uncompressed spun sugar blanket around the edible housing. The uncompressed spun sugar blanket may have a density less than 0.7 g/cm3. The method may include remove the support from the edible housing. The method may include dispose an assembly of the uncompressed spun sugar blanket, the edible housing, and the frozen food core into a package. The method may include apply a flushing agent to an inside of the package. The method may include seal the package. The uncompressed spun sugar blanket may be preserved, by the edible housing, from being dissolved by the frozen food core. The frozen food core may be thermally insulated from an ambient environment by the uncompressed spun sugar blanket.

Apply the spun sugar onto the exterior surface of the edible housing may include projecting spun sugar fibers across an air gap separating a source of the spun sugar to the exterior surface of the edible housing.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A melting-resistant spun sugar and frozen liquid confection comprising:
an edible housing comprising a moisture-resistant molded shell;
a frozen liquid food core substantially entirely enclosed by the edible housing; and,
an uncompressed spun sugar blanket comprising a machine-spun cotton candy configured to substantially encompass the edible housing enclosing the frozen liquid food core, wherein the uncompressed spun sugar blanket has a density less than 0.7 g/cm³; wherein,
the uncompressed spun sugar blanket is preserved, by the edible housing, from being dissolved by the frozen liquid food core, and,
the frozen liquid food core is thermally insulated from an ambient environment by the uncompressed spun sugar blanket.

2. The melting-resistant spun sugar and frozen liquid confection of claim 1, wherein the edible housing comprises a rollup fruit-flavored sheet pre-molded into a predetermined shape.

3. The melting-resistant spun sugar and frozen liquid confection of claim 1, wherein the moisture-resistant molded shell is less than 2 mm thick.

4. The melting-resistant spun sugar and frozen liquid confection of claim 1, wherein the frozen liquid food core comprises a continuous ice-cream core.

5. The melting-resistant spun sugar and frozen liquid confection of claim 1, wherein the frozen liquid food core comprises less than 3 oz of continuous ice-cream, and a total weight of the frozen liquid food core and the enclosing edible housing weighs less than 60 g.

6. The melting-resistant spun sugar and frozen liquid confection of claim 5, wherein an entire volume within a peripheral boundary of the uncompressed spun sugar blanket comprises a volume of at least 42 cm³.

7. The melting-resistant spun sugar and frozen liquid confection of claim 1, wherein the melting-resistant spun sugar and the frozen liquid confection comprises less than 200 kcal of calories.

8. The melting-resistant spun sugar and frozen liquid confection of claim 1, wherein the uncompressed spun sugar blanket is at least ¼ inch thick encompassing the edible housing enclosing the frozen liquid food core.

9. A melting-resistant spun sugar and frozen liquid confection comprising:
an edible housing comprising a moisture-resistant molded shell;
a frozen liquid food core substantially entirely enclosed by the edible housing; and,
an uncompressed spun sugar blanket configured to substantially encompass the edible housing enclosing the frozen liquid food core; wherein,
the uncompressed spun sugar blanket is preserved, by the edible housing, from being dissolved by the frozen liquid food core, and,
the frozen liquid food core is thermally insulated from an ambient environment by the uncompressed spun sugar blanket.

10. The melting-resistant spun sugar and frozen liquid confection of claim 9, wherein the moisture-resistant molded shell comprises a rollup fruit-flavored sheet sheet pre-molded into a predetermined shape.

11. The melting-resistant spun sugar and frozen liquid confection of claim 10, wherein the rollup fruit-flavored sheet sheet is a maximum of 5 inches square when in an un-molded state.

12. The melting-resistant spun sugar and frozen liquid confection of claim 9, wherein the moisture-resistant molded shell is less than 2 mm thick.

13. The melting-resistant spun sugar and frozen liquid confection of claim 9, wherein the frozen liquid food core comprises a continuous ice-cream core.

14. The melting-resistant spun sugar and frozen liquid confection of claim 13, wherein the continuous ice-cream core comprises soft-serve ice cream.

15. The melting-resistant spun sugar and frozen liquid confection of claim 9, wherein the frozen liquid food core comprises less than 3 oz of continuous ice-cream, and a total weight of the frozen liquid food core enclosed by the edible housing weighs less than 60 g.

16. The melting-resistant spun sugar and frozen liquid confection of claim 15, wherein an entire volume within a peripheral boundary of the uncompressed spun sugar blanket comprises a volume of at least 42 cm³.

17. The melting-resistant spun sugar and frozen liquid confection of claim 9, having less than or equal to 200 kcal of total calories.

18. The melting-resistant spun sugar and frozen liquid confection of claim 9, wherein the uncompressed spun sugar blanket comprises a machine-spun cotton candy.

19. The melting-resistant spun sugar and frozen liquid confection of claim 1, wherein the uncompressed spun sugar blanket has a density less than 0.7 g/cm³.

20. The melting-resistant spun sugar and frozen liquid confection of claim 1, wherein the uncompressed spun sugar blanket is at least ¼ inch thick encompassing the edible housing enclosing the frozen liquid food core.
